(19) United States
(12) Patent Application Publication
(10) Pub. No.: US 2018/0297180 A1
(43) Pub. Date: Oct. 18, 2018

(54) SELF STARTING DRIVER

(71) Applicant: Ghislain Jolicoeur, Gatineau (CA)

(72) Inventor: Ghislain Jolicoeur, Gatineau (CA)

(21) Appl. No.: 15/490,078

(22) Filed: Apr. 18, 2017

(51) Int. Cl. B25B 21/02; B25B 23/00

(52) U.S. Cl. CPC B25B 21/023; B25B 23/0035

(57) ABSTRACT

Disclosed herein is a self starting driver and method of use. The self starting driver includes a housing capable of receiving a forward driving torque at the rear end and of transmitting the forward driving torque at the front end; a punch driving tip provided at the front end of the housing so as to receive the forward driving torque; and a punching mechanism capable of providing a self starting forward impulse The punching mechanism releases the self starting forward impulse when the punch driving tip recedes rearwards by a predetermined distance relative to the front end of the housing. The method of using the self starting driver allows to consistently self start and drive a threaded fastener at a start location of a surface, thereby solving the “fly off” problem.

### CROSS-REFERENCE TO RELATED APPLICATIONS

This is the first application filed for the present techniques.

### MICROFICHE APPENDIX

Not applicable.

### TECHNICAL FIELD

This application relates to punches and threaded fastener drivers in general, and to a self starting driver, in particular.

### BACKGROUND OF THE APPLICATION

“Fly off” is a known problem whereby threaded fasteners such as screws and bolts fly off of the surface of a work piece, such as a metal work, soffit, or any other work piece when the threaded fastener is started at a location where no pre-existing hole has been made.

A known solution to this problem is to use a punch in order to create a start location for the threaded fastener. Typically, what is required is to use the punch first to select a start location, and then proceed to drive the threaded fastener at the start location.

An inconvenience in the use of a traditional punch is that a hammer is needed to strike the punch. An improvement is therefore the use of an automatic self centering punch to avoid having to use a separate hammer U.S. Pat. No. 2,384,707 discloses an automatic center punch, and is representative of that class of device that removes the need for a separate hammer.

Despite the existence of such tools, experienced workers typically forego the use of automatic self centering punches in favor of using only their driver because the use of a punch, whether automatic or manual, requires additional operations that take up valuable time, resulting in many threaded fasteners still being subject to “fly off”.

There is therefore still need for improvement, in particular by providing for a self starting driver that solves the “fly off” problem without the need for the skilled worker to change tools and waste valuable time.

### SUMMARY

According to one aspect of the present application, there is provided: a self starting driver suitable for starting and driving a threaded fastener onto the surface of a work piece. The self starting driver includes: a housing capable of receiving a forward driving torque at the rear end and of transmitting the forward driving torque at the front end; a punch driving tip provided at the front end of the housing so as to receive the forward driving torque; and a punching mechanism capable of providing a self starting forward impulse, the punching mechanism provided inside the housing. The punching mechanism releases the self starting forward impulse when the punch driving tip recedes rearwards by a predetermined distance relative to the front end of the housing.

According to another aspect of the present application there is provided: a method of using the self starting driver to self start and drive a threaded fastener at a start location of a surface. The method includes the steps of: engaging a threaded fastener at the front end of the punch driving tip; selecting the start location on the surface by positioning the forward end of the threaded fastener at the desired start location; applying a forward force on the self starting driver until the self starting impulse is triggered by the punching mechanism; and applying a forward torque to the self starting driver thereby causing the threaded fastener to be driven into surface at the selected start location.

Other aspects and features of the present application will become apparent to those ordinarily skilled in the art upon review of the following description of specific embodiments of a self starting driver in conjunction with the accompanying drawing figures.

### BRIEF DESCRIPTION OF THE DRAWINGS

Embodiments of the present application including a preferred embodiment, will now be described, by way of example only, with reference to the accompanying drawing figures, wherein:

FIG. 1A is a perspective view of an exemplary preferred embodiment of a self starting driver;

FIG. 1B is a top view of the self starting driver of FIG. 1A;

FIG. 1C is an rear view of the self starting driver of FIG. 1A;

FIG. 1D is a side view of the self starting driver of FIG. 1A;

FIG. 1E is a front view of the self starting driver of FIG. 1A;

FIG. 2 is an exploded perspective view of the self starting driver of FIG. 1A;

FIG. 3 is an exploded perspective view of the self starting driver of FIG. 1A showing some hidden lines;

FIG. 4A is a perspective sectional view of an exemplary self starting driver of FIG. 1A;

FIG. 4B is a top sectional view of the self starting driver of FIG. 1A;

FIG. 4C is an rear sectional view of the self starting driver of FIG. 1A;

FIG. 4D is a side sectional view of the self starting driver of FIG. 1A;

FIG. 4E is a front sectional view of the self starting driver of FIG. 1A;

FIG. 5A is a side sectional view of the self starting driver of FIG. 1A at a first position;

FIG. 5B is a side sectional view of the self starting driver of FIG. 1A at a second position;

FIG. 5C is a side sectional view of the self starting driver of FIG. 1A at a third position;

FIG. 5D is a side sectional view of the self starting driver of FIG. 1A at a fourth position;

FIG. 5E is a side sectional view of the self starting driver of FIG. 1A at a fifth position;

FIG. 5F is a side sectional view of the self starting driver of FIG. 1A at a sixth position;

FIG. 5G is a side sectional view of the self starting driver of FIG. 1A at a seventh position;

FIG. 5H is a side sectional view of the self starting driver of FIG. 1A at a eighth position;

FIG. 5I is a side sectional view of the self starting driver of FIG. 1A at a ninth position; and

FIG. 5J is a side sectional view of the self starting driver of FIG. 1A at a tenth position;

Like reference numerals are used in different figures to denote similar elements.

### DETAILED DESCRIPTION OF THE DRAWINGS

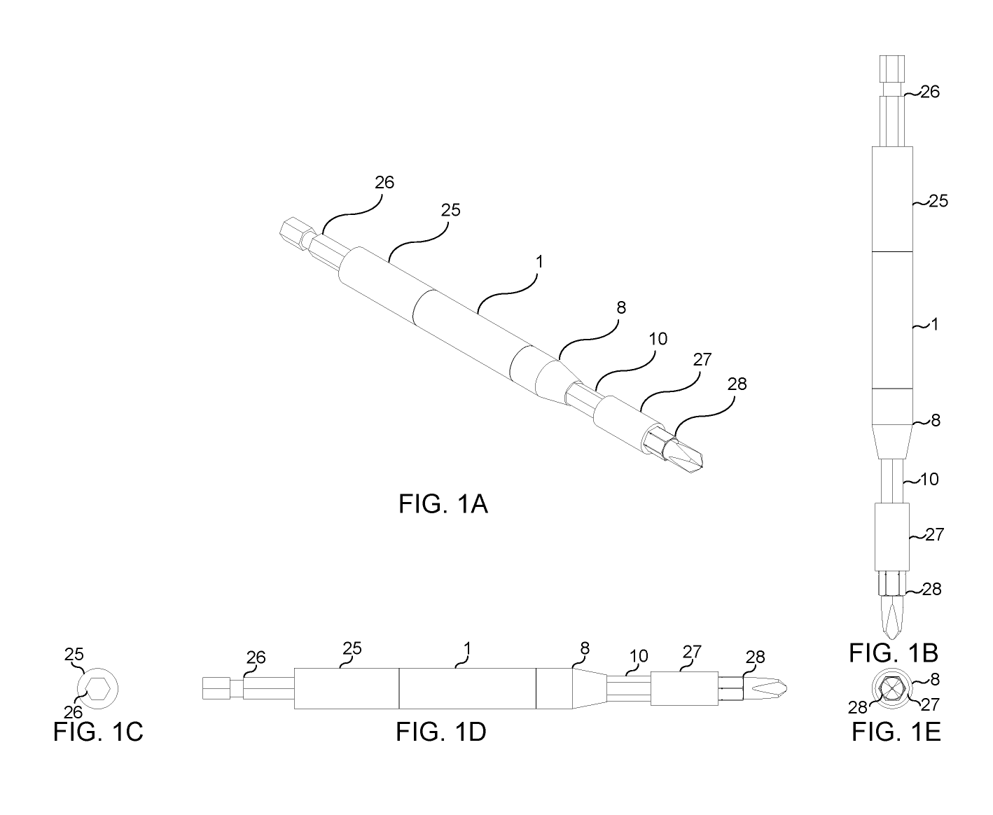

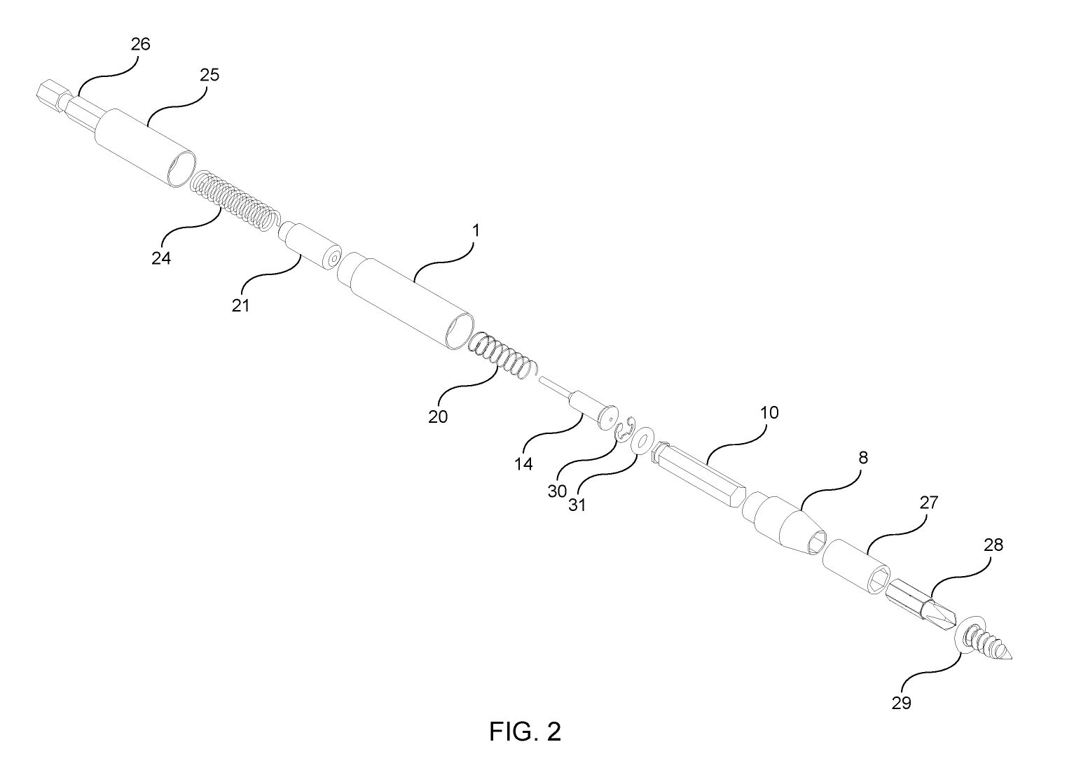

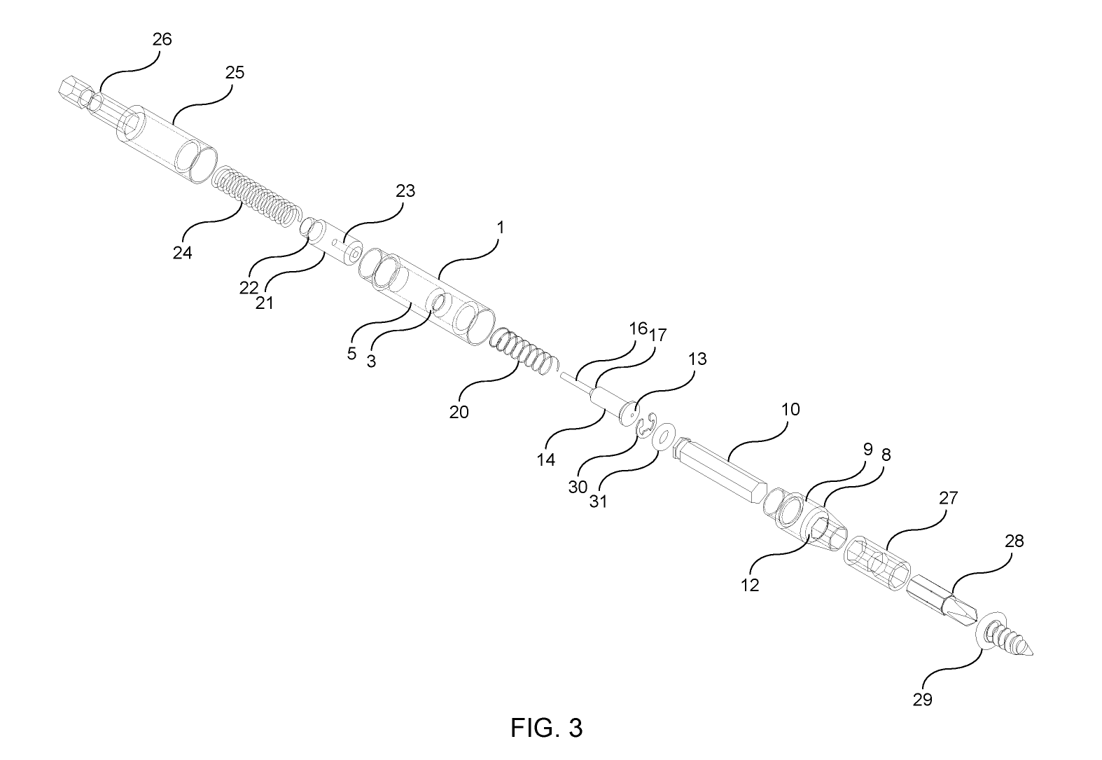

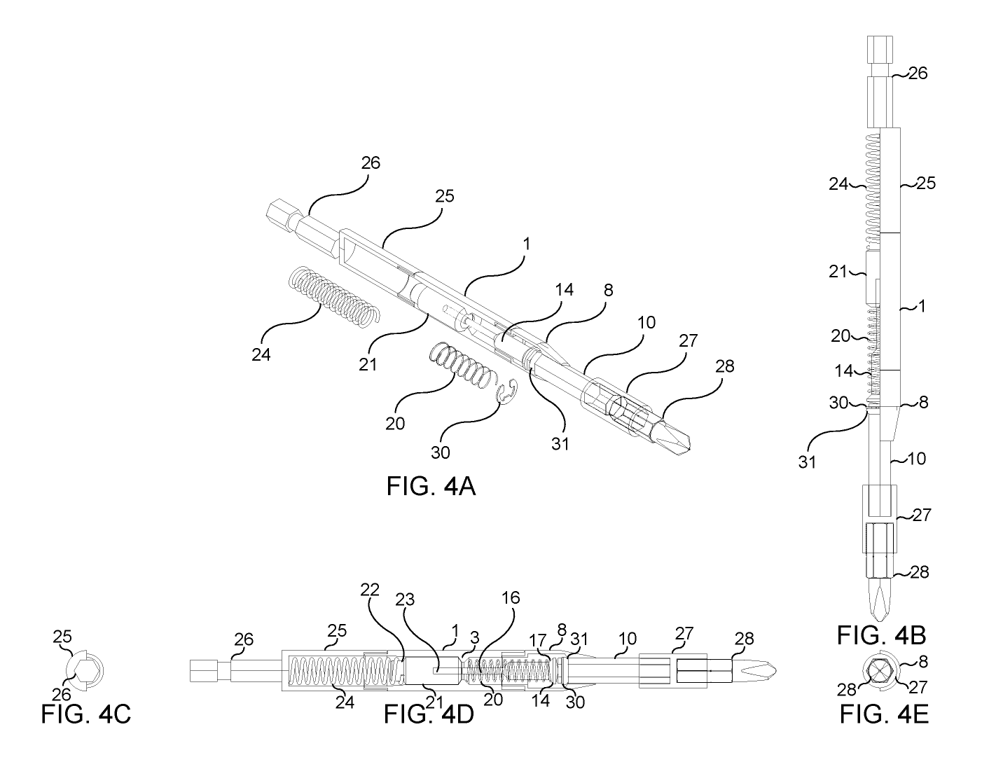

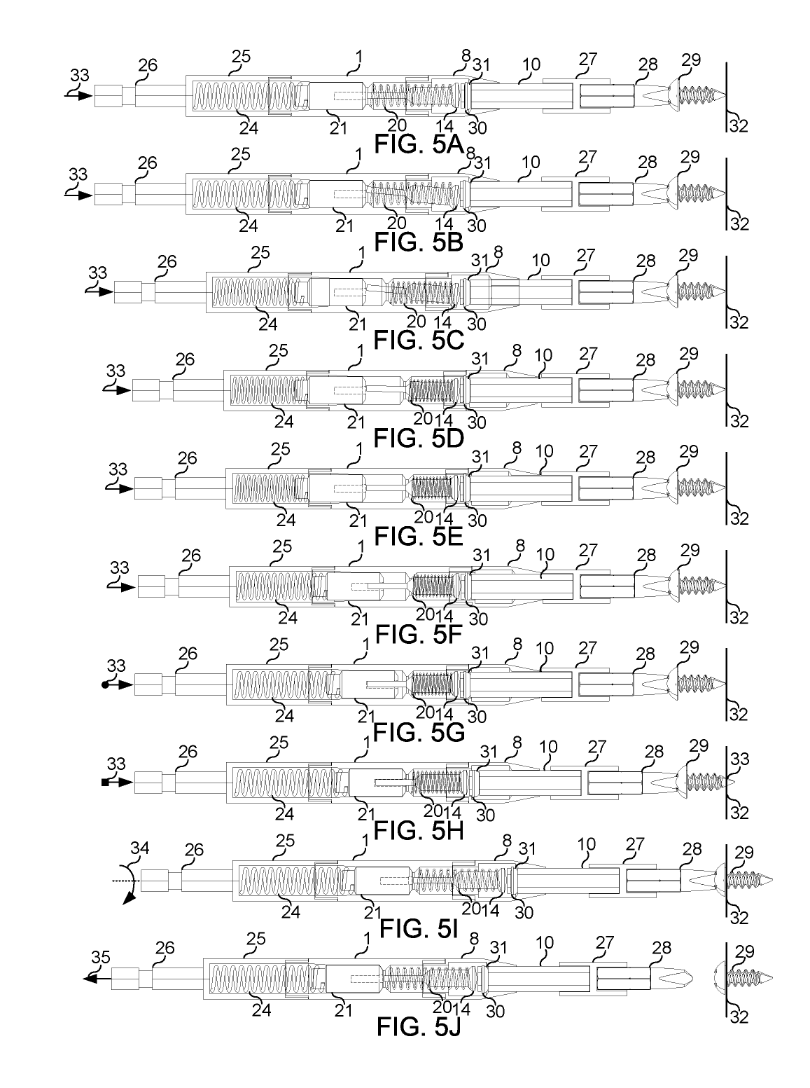

Referring to the drawings, FIGS. 1A-E, 2, 3, 4A-E, and 5A-J illustrate an exemplary preferred embodiment of a self starting driver. The self starting driver illustrated includes a housing generally formed by a body 1, which brings together a punch driving guide 8 at the front end, and a drive cap 25 at the rear end. The drive cap 25 further includes a driving shaft 26, such that forward torque applied to the driving shaft 26 is conveyed to the body 1, which in turn conveys it to the punch driving guide 8. The punch driving guide 8 receives a punch driving tip 10 such that the punch driving tip 10 is able to receive the forward torque applied to the housing at the driving shaft 26. The punch driving tip 10 is connected to an adapter 27 to adapt the punch driving tip 10 to receive a driver bit 28 such that the adapter 27 conveys forward torque to the driver bit 28, and ultimately to the screw 29, or more generally a threaded fastener, including for example a bolt. When a force is applied between the rear of the housing and the front of the punch driving tip 10, the punch driving tip 10 recedes into the housing until an impulse is triggered by a punching mechanism provided inside the housing. Thus, with the adapter 27, driver bit 28 and screw in place, the tip of the threaded fastener acts as the tip of a traditional punch to enable the screw to self start. Although an exemplary and preferred punching mechanism is illustrated, it is envisaged that any mechanism capable of imparting a triggered impulse can be used without departing from the scope of this application.

The drive cap 25 is dimensioned to have a bore to receive a compression spring 24 onto which sits a hammer 21. In a normal assembled position, the compression spring 24 exerts a force between the drive cap 25 to keep the hammer 21 at rest against the shoulder 3 of the body 1 inside the bore 5. The shoulder 3 divides the bore 5 of the body 1 into a rear portion and a front portion. The hammer 21 is shouldered at 22 and a blind bore 23 is formed centrally therein, dimensioned to just receive and guide the stem 16 of tumbler 14. The driver cap 25 and body 1 can be assembled using a mechanism to adjust the distance between them so as to control the amount of force exerted by the compression spring 24 onto the hammer 21, while still allowing for torque to be conveyed from the driving shaft 26 to the housing. In a preferred embodiment, the drive cap 25 is fixedly assembled with the body 1. Alternatively, the housing parts are releasably assembled. For example, a inner thread provided at the front of the driver cap 25, and a corresponding outer thread provided at the rear of the body 1, as well as a locking nut and washer (not shown) can be provided to keep the assembly from unthreading when a forward driving torque is applied to the driving shaft 26. The tumbler 14 is of spindle form, and the construction or form of the front face 13 of the tumbler 14 is correlated with the construction or form of the rear face of punch driving tip 10 so as to enable these faces to cooperate to hold the tumbler 14 normally in a position that will enable it to engage the forward face of the hammer 21 and impart a rearward movement to the hammer 21. For example, the front end of the tumbler 14 is provided with an angled surface 13 such that when force is applied onto the tumbler 14 at the front end towards the back end, the tumbler will be biased such that the stem 16 is not aligned with the blind bore 23 of the hammer 21, but instead exerts a force against the hammer 21 so as to compress the compression spring 24 as it moves the hammer 21 towards the rear. The front portion of the bore 5 receives a coil 20. The coil 20 accomplishes two functions: first, the coil 20 ensures that the punch driving tip 10 is biased to return to the front of the housing. Second, the coil 20 improves the bias of the tumbler 14 to engage the front face of the hammer 21 which, at rest biases the stem 16 of the tumbler 14 so that it is not aligned with blind bore 23 of the hammer 21 and instead engages the forward face of the hammer 21 A taper 17 is provided at the base of the stem 16 of the tumbler 14 such that when the tumbler 14 reaches the shoulder 3 of body 1 the tumbler 14 self centers and the stem 16 is aligned with the blind bore 23 of the hammer 21. At this point the hammer is propelled forward by action of the compression spring 24 so as to strike the tumbler 14, which in turn imparts that impulse to the punch driving tip 10 and any further elements assembled thereon. The punch driving guide 8 has a small bore fitting to and of profile correlated with the profile of the punch driving tip 10 so as to allow rearward and forward displacement of the punch driving tip 10, while preventing any free rotation of the punch driving tip 10. A larger counter bore 9 is provided in punch driving guide 8 to receive the tumbler 14 so as to be able to make contact with punch driving tip 10. The difference in profiles of the bore and counter bore 9 result in a shoulder 12 which is used in conjunction with correlated form or construction of punch driving tip 10 so as to prevent punch driving tip 10 to fully escape in a forward direction from punch driving guide 8. As illustrated in the example, the punch driving tip 10 is provided with a groove near the rear so as to receive gasket 31 and snap ring 30 that cooperate with shoulder 12 to prevent the full escape of punch driving tip 10 from the punch driving guide 8. In a preferred embodiment, the body 1 is fixedly assembled with the punch driving guide 8. Alternatively, the housing parts are releasably assembled. For example, a inner thread is provided at the front of the body 1, and a corresponding outer thread is provided at the rear end of the punch driving guide 8 such that the threads will keep the assembly from unthreading when a forward driving torque is applied to the driving shaft 26. An adapter 27 is provided with a rear bore and a forward bore, each having a profile correlated to receive the punch driving tip 10 and driver bit 28, respectively, and convey forward torque from the former to the latter. As illustrated, the interface between the screw 29 and the driver bit 28 is cross-shaped for illustrative purposes only—it is envisaged that any interface capable of conveying forward torque can be used depending on the application. Likewise, the interface between the adapter 27, the punch driving tip 10, the punch driving guide 8 have a hexagonal profile for illustrative purposes only—any profile capable of conveying forward torque can be used depending on the application.

Operationally, at a first position a screw 29 is engaged with a corresponding driver bit 28, and the tip of screw 29 is positioned at a selected start location onto a surface 32, such as for example the surface of a work piece, such as metal sheet or work, onto which a screw is desired to be driven. A forward force 33 is applied on the driving shaft 26 such that the tumbler 14 and its stem 16 engages the front face of the hammer 21 at a second position. As further force 33 is applied, the housing displaces forward thereby compressing compression spring 25 at a third position. At a critical fourth position, the self centering action of the tumbler 14 provided by the taper 17 and corresponding shoulder 3 causes the stem 16 to begin to align with blind bore 23. At a fifth position, the blind bore 23 and the stem 16 are aligned, and the hammer 21 begins its forward movement due to the release of the energy accumulated in compression spring 25 while the tumbler 14 remains substantially at rest against the front of the shoulder 3. At a sixth position, the hammer 21 is moving forwards but has not yet struck the tumbler 14. At a seventh position, the hammer 21 strikes the tumbler 14. At an eighth position, the impact of the hammer 21, conveyed via the tumbler 14, the punch driving tip 10, the adapter 27, and the driver bit 28 causes the screw 29 to punch the surface 32 at the selected start location. At a ninth position, forward torque 34 is applied to drive shaft 26 thereby causing screw 29 to be driven into surface 32, advantageously at the selected start location for driving screw 29 selected at the first position. At a tenth position, a rearward force 35 is applied at the driving shaft 26 to disengage the driver bit 28 from the screw 29 and reset the elements so that they are ready for receiving and driving another screw at another select start location.

In a preferred embodiment, the length of tumbler 14 is correlated to the length of the screw 29 such that the amount of forward travel in the housing between the first position and the ninth position is a function of the length of the screw 29. In alternate embodiments, the length of tumbler 14 is: substantially the same length as the screw 29 such that the forward force of the coil 20 is applied only until the screw 29 is substantially flush with the surface 32; of smaller length to require an external force to continue to drive the screw 29 to be flush or countersunk with the surface 32, or greater than the length of the screw 29 to allow that the force of the coil 20 continues to drive the screw 29 forward until it is countersunk with the surface 32.

Although in the drawings, the profiles of driving shaft 26, punch driving tip 10, adapter 27 and driver bit 28 are all illustrated as being hexagonal, it is envisaged that any other profiles, such as square, star, triangular, or more generally a profile that is able to convey forward torque may be used at one or all profiles, and that these need not be all the same. In an alternative embodiment, the driver bit 28 can be an integral part of the punch driving tip 10 such that adapter 27 is not needed. In an alternative embodiment, the shape of the driver cap 25 is such that it can be used to drive torque such that a separate drive shaft 26 is not needed. More generally, when used with a screw driver handle, power driver, or drill to drive the forward torque 34, any shape that can be fit into the chuck of a power driver or drill, or screw driver handle, can be used either for the shape of driver cap 25 or drive shaft 26. In an alternative embodiment, the housing is provided integral to a screw driver handle, power driver or drill. In alternative embodiments, different sized tumblers 14 and punch driving tips 10 are provided to correspond to different sized screws 29 such that the travel of the tumbler 14 before it aligns with the blind bore 23 is a function of the length of the corresponding screw between its tip and the shoulder of the head of the screw. In alternative embodiments, the driver bit 28 is not needed so as to be able to drive a bolt, the foreword bore in the adapter 27 being dimensioned and of a profile able to receive the head of the bolt instead of a driver bit 28.

The above-described embodiments of the present application are intended to be examples only. Those of skill in the art may effect alterations, modifications and variations to the particular embodiments without departing from the scope of the application, which is set forth in the claims.

What is claimed is:

1. A self starting driver suitable for starting and driving a threaded fastener onto the surface of a work piece, the self starting driver comprising:
(a) a housing capable of receiving a forward driving torque at the rear end and of transmitting the forward driving torque at the front end;
(b) a punch driving tip provided at the front end of the housing so as to receive the forward driving torque;
(c) a punching mechanism capable of providing a self starting forward impulse, the punching mechanism provided inside the housing;
wherein the punching mechanism releases the self starting forward impulse when the punch driving tip recedes rearwards by a predetermined distance relative to the front end of the housing.

2. The self starting driver of claim 1, wherein the housing includes a driver cap for receiving the forward driving torque.

3. The self starting driver of claim 2, wherein the driver cap includes a driver shaft for receiving the forward driving torque.

4. The self starting driver of claim 1, wherein the driver cap includes a thread for releasable attachment to the remainder of the housing.

5. The self starting driver of claim 1, wherein the housing includes a punch driving guide at the front of the housing for receiving the punch driving tip.

6. The self starting driver of claim 5, wherein the punch driving guide is provided with a thread for releasable attachment to the remainder of the housing.

7. The self starting driver of claim 1, wherein the housing includes a body between the rear end and the front end of the housing, the body including a shoulder defining a rear portion and forward portion of a bore inside the housing.

8. The self staring driver of claim 5, wherein the body includes at least one thread for releasable attachment to the remainder of the housing.

9. The self starting driver of claim 5, wherein the punching mechanism includes:
(a) a compression spring provided at the rear portion of the bore;
(b) a hammer sitting between the front end of the compression string and the shoulder, the hammer including a blind bore with the opening on its forward face; and
(c) a tumbler provided at the front end of the bore, having a stem at its rear end constructed to fit in and be guided by the blind bore of the hammer, the tumbler further having a taper to self center the tumbler when the taper contacts the shoulder of the bore;
wherein the tumbler engages the front face of the hammer to compress the compression spring when the punch driving tip recedes rearwards by less than a predetermined distance relative to the front end of the housing; and
wherein the compression spring decompresses when the punch driving tip recedes rearwards by at least a predetermined distance relative to the front end of the housing, thereby causing the hammer to strike the tumbler to impart the self starting forward impulse onto the punch driving tip.

10. The self starting driver of claim 9, wherein the tumbler has an angled forward face to bias the stem of the tumbler away from alignment with the blind bore of the hammer when the punch driving tip recedes into the housing.

11. The self starting driver of claim 9, further comprising a coil is provided for at least one of: biasing the tumbler towards the front of the housing; and biasing the stem of the tumbler away from the blind bore of the hammer

12. The self starting driver of claim 9, wherein the punch driving bit includes a groove at the rear end for receiving at least one of: a gasket; and a snap ring; to keep the punch driving bit from completely escaping from the front end of the housing.

13. The self starting driver of claim 1, wherein at least one element of the self starting driver includes a profile selected from the following profiles: hexagonal, square, triangular and cross.

14. The self starting driver of claim 1 further comprising a driver bit provided at the front end of the punch driving tip.

15. The self starting driver of claim 14, wherein the driver bit is provided integral to the punch driving tip.

16. The self starting driver of claim 14, further including an adapter provided at the front end of the punch driving tip between the punch driving bit and the driver bit to adapt the punch driving tip to the driver bit.

17. The self staring driver of claim 1, further comprising an adapter provided at the front end of the punch driving tip.

18. The self starting driver of claim 17, wherein the adapter is able to receive a threaded fastener.

19. A method of using a self starting driver of claim 1 to self start and drive a threaded fastener at a start location of a surface, the method including the steps of:
(a) engaging a threaded fastener at the front end of the punch driving tip;
(b) selecting the start location on the surface by positioning the forward end of the threaded fastener at the desired start location;
(c) applying a forward force on the self starting driver until the self starting impulse is triggered by the punching mechanism; and
(d) applying a forward torque to the self starting driver thereby causing the threaded fastener to be driven into surface at the selected start location.

20. The method of claim 19, further comprising the step of applying a rearward force to the self staring driver to disengage from the threaded fastener and reset the punching mechanism.
